(19) United States
(12) Patent Application Publication
(10) Pub. No.: US 2023/0373842 A1
(43) Pub. Date: Nov. 23, 2023

(54) SYSTEM AND METHODS FOR MANUFACTURING A GLASS RIBBON

(71) Applicant: CORNING INCORPORATED, Corning, NY (US)

(72) Inventors: James William Brown, The Villages, FL (US); Keith Mitchell Hill, Horseheads, NY (US); Mark Thomas Massaro, Murray, KY (US); Stephane Poissy, Brunoy (FR)

(21) Appl. No.: 18/027,243

(22) PCT Filed: Nov. 23, 2021
(86) PCT No.: PCT/US2021/060437

§ 371 Date: Mar. 20, 2023

Related U.S. Application Data
(60) Provisional application No. 63/213,237, filed on Jun. 22, 2021.
(60) Provisional application No. 63/117,722, filed on Nov. 24, 2020.

(51) Int. Cl. C03B 35/18; C03B 35/16; B65H 20/02; B65H 23/188; B65H 23/192

(52) U.S. Cl. CPC C03B 35/188; C03B 35/163; C03B 35/165; B65H 20/02; B65H 23/1888; B65H 23/192; B65H 2301/44324; B65H 2404/1541; B65H 2701/19; B65H 2403/93; B65H 2404/117

(57) ABSTRACT

A manufacturing system is disclosed including a conveying apparatus with a plurality of rollers that form a travel path along which a ribbon is configured to be conveyed in a travel direction. The plurality of rollers including at least a tensioning roller having a shaft and a rotation wheel with a plurality of spokes that extend radially outward from the shaft, the plurality of spokes being configured to rotate about a longitudinal axis of the shaft to cause the ribbon to be conveyed in the travel direction. The manufacturing system further including a flow generator configured to direct a flow of fluid to the plurality of spokes to cause rotation of the plurality of spokes.

This Application claims priority under 35 USC § 119(e) from U.S. Provisional Patent Application Ser. No. 63/213,237 filed on Jun. 22, 2021 and U.S. Provisional Patent Application Ser. No. 63/117,722 filed on Nov. 24, 2020, which are incorporated by reference herein in its entirety.

### FIELD

The present disclosure relates generally to systems and methods for manufacturing a glass ribbon and, more particularly, to systems and methods for manufacturing a glass ribbon with a conveying apparatus.

### BACKGROUND

Glass manufacturing apparatuses are commonly used to form various glass products for sheet glass used in display applications. The glass ribbon can be stored by winding the glass ribbon into a roll with a winding apparatus. As the thickness of the glass ribbon decreases, these sheets become more flexible. This creates a challenge from a handling perspective. For example, the glass ribbon may experience sag during transport to a sheeting system.

### SUMMARY

The following presents a simplified summary of the disclosure to provide a basic understanding of some embodiments described in the detailed description.

Embodiments of the present disclosure provide a glass manufacturing system that includes a conveying apparatus with a plurality of rollers and a flow generator. The plurality of rollers include a tensioning roller, and the flow generator is configured to direct a flow of fluid to the tensioning roller. Such provides a precise and specific rotation of the tensioning roller, which in turn causes a specific conveyance force to the glass ribbon. Therefore, the glass ribbon is conveyed along the conveying apparatus with an easily controlled speed and conveyance rate. Such allows thin glass ribbon to be easily conveyed without any sag of the glass ribbon between adjacent rollers and without causing slippage between the glass ribbon and the rollers, both of which can cause imperfections in the glass ribbon. Therefore, the glass manufacturing system disclosed herein produces superior glass ribbon sheets with reduced imperfections. Additionally, the glass manufacturing system disclosed herein reduces the recovery time when a glass ribbon does happen to break on the conveying apparatus.

Aspects of the present disclosure include a manufacturing system comprising a conveying apparatus and a flow generator. The conveying apparatus comprising a plurality of rollers that form a travel path along which a ribbon is configured to be conveyed in a travel direction. The plurality of rollers comprising at least a tensioning roller comprising a shaft and a rotation wheel with a plurality of spokes that extend radially outward from the shaft, the plurality of spokes being configured to rotate about a longitudinal axis of the shaft to cause the ribbon to be conveyed in the travel direction. The flow generator being configured to direct a flow of fluid to the plurality of spokes to cause rotation of the plurality of spokes.

Aspects of the present disclosure also include a method of manufacturing a ribbon, the method comprising directing a flow of fluid to a plurality of spokes to rotate the plurality of spokes and convey a ribbon along a travel path of a conveying apparatus in a travel direction such that the plurality of spokes do not contact the ribbon. The plurality of spokes being attached to a shaft such that the shaft does not contact the ribbon.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 schematically illustrates an exemplary glass manufacturing system according to embodiments of the present disclosure;

FIG. 2 illustrates a perspective view of a conveying apparatus of the glass manufacturing system according to embodiments of the present disclosure;

FIG. 3 illustrates an enlarged view of a portion of the conveying apparatus of FIG. 2 according to embodiments of the present disclosure; and

FIG. 4 illustrates another enlarged view of a portion of the conveying apparatus of FIG. 2 according to embodiments of the present disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, another embodiment includes from the one value to the other value. Similarly, when values are expressed as approximations by use of the antecedent “about,” it will be understood that the value forms another embodiment. It will be further understood that the endpoints of each of the ranges are significant both in relation to the other endpoint, and independently of the other endpoint.

Directional terms as used herein—for example up, down, right, left, front, back, top, bottom, upper, lower, etc.—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering., etc. Rather, such terms are merely used as identifiers, names, etc. for features, elements, items, etc. For example, a first end and a second end generally correspond to end A and end B or two different or two identical ends or the same end.

The present disclosure relates to a glass manufacturing system and methods for manufacturing a glass ribbon. For purposes of this application, “glass ribbon” may be considered one or more of a glass ribbon in a viscous state, a glass ribbon in an elastic state (e.g., at room temperature) and/or a glass ribbon in a viscoelastic state between the viscous state and the elastic state. Methods and apparatus for forming a glass ribbon will now be described by way of example embodiments. For purposes of the disclosure, in some embodiments, a glass manufacturing apparatus can comprise a glass forming apparatus that forms a glass article (e.g., a glass ribbon) from a quantity of molten material. In some embodiments, the glass ribbon can be employed in a variety of display applications comprising, but not limited to, liquid crystal displays (LCDs), electrophoretic displays (EPD), organic light emitting diode displays (OLEDs), plasma display panels (PDPs), touch sensors, photovoltaics, foldable phones, etc.

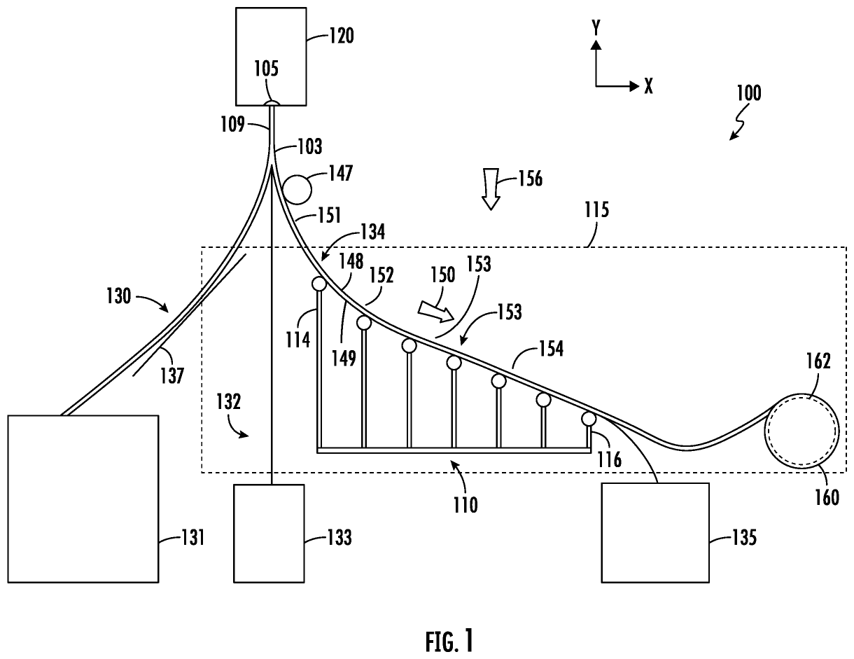

With reference to FIG. 1, a glass manufacturing system 100 is schematically illustrated. System 100 comprises a conveying apparatus 110 and a forming apparatus 120. As discussed further below, conveying apparatus 110 forms a travel path along which a ribbon 103, such as a glass ribbon, moves. Forming apparatus 120 is configured to form glass ribbon 103 and, in some embodiments, comprises a slot draw apparatus, float bath apparatus, down-draw apparatus, up-draw apparatus, press-rolling apparatus, or other glass forming apparatus known in the art that forms a glass ribbon. Forming apparatus 120 may further comprise a delivery conduit, such as opening 105, through which glass ribbon 103 exits. The delivery conduit can be oriented along a direction of gravity such that glass ribbon 103 flows downwardly along the direction of gravity through the delivery conduit.

Forming apparatus 120 can be positioned exterior of a clean room environment 115, with one or more other portions of glass manufacturing system 100 being positioned within the clean room environment 115, as shown in FIG. 1. Clean room environment 115 can be contained within one or more walls (e.g., illustrated with dashed lines in FIG. 1) and may comprise a reduced level of particulates (e.g., dust, airborne organisms, vaporized particles, etc.) as compared to a level of particulates at an exterior of clean room environment 115. In some embodiments, clean room environment 115 may be maintained at a positive pressure relative to an exterior of clean room environment 115 such that air may flow from clean room environment 115 to an environment exterior to clean room environment 115. In some embodiments, a pressure differential between clean room environment 115 and the exterior environment may be about 5 pascals or more. Accordingly, the pressure within clean room environment 115 may be about 5 pascals or more greater than the pressure within the exterior environment. In some embodiments, clean room environment 115 comprises an ISO (“International Organization for Standardization”) 6 clean room.

As shown in FIG. 1, glass ribbon 103 moves along one or more travel paths after it exits forming apparatus 120. More specifically, glass ribbon 103 can move along a first travel path 130, a second travel path 132, and/or a third travel path 134. Forming apparatus 120 first defines an upstream portion 109 of the travel path before glass ribbon 103 flows along first, second, or third travel paths 130, 132, 134. Thus, forming apparatus 120 conveys the glass ribbon 103 along the upstream portion 109 of the travel path. From there, glass ribbon 103 can either be conveyed along first travel path 130, second travel path 132, or third travel path 134.

In some embodiments, glass manufacturing system 100 comprises a diverter 137 that direct glass ribbon 103 to first travel path 130. Diverter 137 can comprise, for example, a surface that guides glass ribbon 103 along first travel path 130. In some embodiments, glass ribbon 103 is conveyed along first travel path 130 and into a first disposal apparatus 131, where the glass is crushed for disposal. Thus, glass ribbon 103 conveyed along first travel path 130 may be glass ribbon that is classified as suboptimal glass that is to be destroyed or recycled. For example, the glass ribbon may have an imperfection.

Glass ribbon 103 can also be directed along second travel path 132. As shown in FIG. 1, second travel path 132 may be non-parallel to first travel path 130. In some embodiments, second travel path 132 is parallel (or substantially parallel) to a direction of gravity (e.g., downward in FIG. 1). Thus, glass ribbon 103 can travel along second travel path 132 under the influence of gravity. Furthermore, second travel path 132 can be parallel to a direction of upstream portion 109. Glass ribbon 103 may be conveyed along second travel path 132 and into a second disposal apparatus 133, where the glass is crushed for disposal. Thus, glass ribbon 103 conveyed along second travel path 132 may be glass ribbon that is classified as suboptimal glass that is to be destroyed or recycled. For example, the glass ribbon may have an imperfection.

It is noted that glass ribbon 103 may be directed to second disposal apparatus 133 during a start-up phase of glass manufacturing system 100 when glass ribbon 103 is still very thick and has not yet reached its target thickness (for example, in some embodiments, when glass ribbon 103 has a thickness of about 10 mm or greater). When glass ribbon 103 is very thick, it cannot be bent and, thus, is not suitable for conveying apparatus 110. Glass ribbon 103 may be directed to first disposal apparatus 131 when it is thin enough to be bent but is classified as suboptimal glass.

As shown in FIG. 1, first and second disposal apparatuses 131, 133 can each be located exterior of clean room environment 115. Therefore, the crushing of glass ribbon 103 in the disposal apparatuses occurs outside of clean room environment 115, which greatly reduces any glass particles from entering clean room environment 115.

Glass ribbon 103 can also be directed along third travel path 134. As shown in FIG. 1, third travel path 134 can be a curved travel path that is non-parallel to second travel path 132 and to first travel path 130. Third travel path 134 extends within clean room environment 115. Furthermore, third travel path 134 is defined by conveying apparatus 110. As discussed further below, conveying apparatus 110 comprises a plurality of rollers that form third travel path 134 along which glass ribbon 103 is conveyed in a travel direction.

Conveying apparatus 110 is positioned downstream of forming apparatus 120. As shown in FIG. 1, glass manufacturing system 100 may comprise a support roller 147 between forming apparatus 120 and conveying apparatus 110. Support roller 147 may facilitate engagement of glass ribbon 103 with conveying apparatus 110. In some embodiments, support roller 147 engages a first major surface 148 of glass ribbon 103 and conveying apparatus 110 engages a second major surface 149 of glass ribbon 103. As such, support roller 147 can guide glass ribbon 103 towards and into engagement with conveying apparatus 110. In some embodiments, support roller 147 comprises a contactless support structure, for example, an air bearing that does not contact glass ribbon 103.

Conveying apparatus 110 extends between a first end 114 and a second end 116. First end 114 may be located closer to forming apparatus 120 than second end 116 such that first end 114 may initially receive glass ribbon 103. Furthermore, first end 114 may be located at a higher elevation than second end 116 (e.g., first end 114 is vertically above second end 116). Therefore, third travel path 134 may be angled downwardly from first end 114 to second end 116. Thus, third travel path 134 may be non-parallel and non-perpendicular to a direction of gravity 156.

Third travel path 134 of conveying apparatus 110 may form travel direction 150 that is comprised of a plurality of travel directions. More specifically, travel direction 150 may comprise, for example a first travel direction 151, a second travel direction 152, a third travel direction 153, and a fourth travel direction 154. Travel directions 151-154 may each have a unique and different slope with regard to the other travel directions. The slope of each travel direction may be dependent on the height of the rollers of conveying apparatus 110, as discussed further below. First travel direction 151 may have a first slope, second travel direction 152 may have a second slope, third travel direction 153 may have a third slope, and fourth travel direction 154 may have a fourth slope such that each of the first, second, third, and fourth slopes are different and unique from each other. Therefore, third travel path 134 has a non-constant slope along travel directions 151-154. In some embodiments, third slope is greater than fourth slope, second slope is greater than third slope, and first slope is greater than second slope. Thus, first slope has the greatest vertical change compared to the other slopes.

As further shown in FIG. 1, travel direction 150 (comprised of first, second third, and fourth travel directions 151-154) forms a curved travel direction such that third travel path 134 is a curved travel path. Thus, one or more portions of third travel path 134 deviates from a straight line formed between first end 114 and second end 116.

Conveying apparatus 110 may direct glass ribbon 103 to a third disposal apparatus 135 if it is determined that the glass is suboptimal and classified as to be destroyed or recycled. For example, the glass ribbon may have an imperfection. Third disposal apparatus 135 may be disposed exterior of clean room environment 115. Alternatively, conveying apparatus 110 may direct glass ribbon 103 to a winding apparatus 160, where glass ribbon 103 is wound into a roll. Winding apparatus 160 can comprise, for example, a spool 162 with a substantially circular cross-sectional shape.

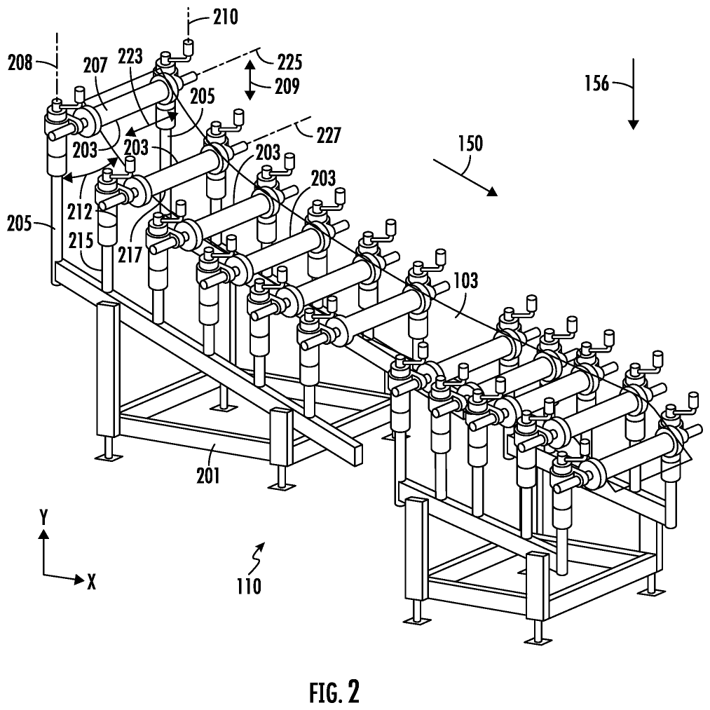

FIG. 2 illustrates a perspective view of conveying apparatus 110. As shown in FIG. 2, conveying apparatus 110 may comprise a support structure 201 that supports a plurality of rollers 203. For example, in some embodiments, support structure 201 comprises a first pair of support arms 205 that support a first roller 207. A first end of first roller 207 can be attached to one of the first pair of support arms 205 and an opposing second end of the first roller 207 can be attached to another of the first pair of support arms 205. In some embodiments, the first pair of support arms 205 can be vertically adjustable, for example, along a first direction 209 that is parallel to the direction of gravity 156 and angled relative to third travel path 134. For example, by being angled relative to third travel path 134, the first pair of support arms 205 can extend along axes, for example, a first arm axis 208 and a second arm axis 210. Adjustment of the first pair of support arms 205 causes the support arms to move vertically (either higher or lower) to raise or lower first roller 207.

In some embodiments, third travel path 134 forms an angle 212 relative to the axes 208, 210 of the first pair of support arms 205 (e.g., and, thus, the direction of gravity 156) that may be within a range from about 0 degrees to about 90 degrees, or within a range from about 15 degrees to about 75 degrees, or within a range from about 30 degrees to about 60 degrees, etc. By being vertically adjustable along the first direction 209, the first pair of support arms 205 can raise or lower first roller 207, which changes angle 212 of third travel path 134 relative to the axes 208, 210 of the first pair of support arms 205 (e.g., and, thus, the direction of gravity 156) adjacent to the first pair of support arms 205.

In some embodiments, support structure 201 further comprises a second pair of support arms 215 that support a second roller 217. A first end of second roller 217 can be attached to one of the second pair of support arms 215 and an opposing second end of the second roller 217 can be attached to another of the second pair of support arms 215. In some embodiments, the second pair of support arms 215 can be vertically adjustable, for example, along the first direction 209 (as discussed above with regard to first pair of support arms 205). Support structure 201 can comprise additional support arms and rollers that may be spaced apart along a length of conveying apparatus 110 in the travel direction 150. The other rollers of the plurality of rollers 203 may be substantially identical to or different from each of first roller 207 and second roller 217, as discussed further below.

As shown in FIG. 2, first support arms 205 may be spaced a distance apart from second support arms 215, such that first roller 207 and second roller 217 are also spaced apart the same distance. In some embodiments, the other support arms and rollers may be spaced apart from second support arms 215 and second roller 217 along travel direction 150. In some embodiments, second roller 217 may be at a different elevation than first roller 207, for example, with second roller 217 at a lower elevation than first roller 207. As such, glass ribbon 103 can first contact conveying apparatus 110 at first roller 207 prior to contacting second roller 217. The different orientations of the support arms and rollers provides the different slopes of travel directions 151-154.

In some embodiments, as shown in FIG. 2, the plurality of rollers 203 extend along a width 223 of glass ribbon 103 such that a length of each roller 203 extends substantially perpendicular to travel direction 150 (e.g., travel directions 151-154). Therefore, longitudinal axes of the plurality of rollers 203 (e.g., a first axis 225 of the first roller 207, a second axis 227 of the second roller 217, etc.) are perpendicular to travel direction 150 of glass ribbon 103 and may be parallel to a major surface (e.g., first major surface 148 or second major surface 149) of glass ribbon 103. In some embodiments, the width 223 of the plurality of rollers 203 may be greater than a width of the glass ribbon 103 such that the glass ribbon 103 can be supported at opposing edges of the glass ribbon 103 (as discussed further below).

As discussed above, the vertical height of each of the plurality of rollers can provide the different travel directions 151-154. Thus, glass ribbon 103 can travel along conveying apparatus 110 at different orientations. For example, glass ribbon 103 may travel along conveying apparatus 110 at different inclines. In some embodiments, conveying apparatus 110 can receive glass ribbon 103 in a substantially vertical orientation (e.g., substantially parallel to the direction of gravity). Conveying apparatus 110 can then gradually re-orient glass ribbon 103 to an orientation with a reduced incline that is closer to a horizontal orientation (e.g., substantially perpendicular to the direction of gravity). Overall, glass ribbon 103, when supported by and disposed on conveying apparatus 110, may form a catenary curve.

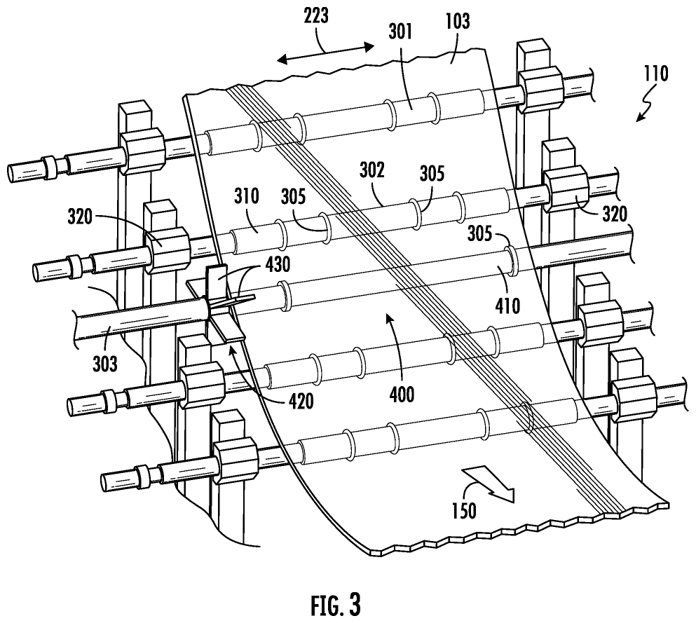

FIG. 3 depicts a close-up view of a portion of conveying apparatus 110. As shown in FIG. 3, the plurality of rollers 203 can comprise a third roller 301, a fourth roller 302, and a fifth roller 303. The third roller 301 and the fourth roller 302 may be substantially identical to the first roller 207 and the second roller 217, as shown in FIG. 2. Each roller of the plurality of rollers 203 may comprise a shaft 310 and one or more support rings 305 that extend radially outward from shaft 310. As shown in FIG. 3, fourth roller 302, for example, comprises four support rings 305. However, it is also contemplated that each roller may comprise more or less support rings 305. For example, the rollers may comprise one, two, three, five, six, seven, eight, nine, or ten or more support rings 305. One or more rollers may comprise a different number of support rings 305 from one or more other rollers. In some embodiments, support rings 305 are located a distance of about 50 mm or less from a peripheral edge of glass ribbon 103. In yet other embodiments, support rings 305 are located a distance of about 40 mm or less, or about 30 mm or less, or about 20 mm or less, or about 10 mm or less, or about 5 mm or less, or about 2 mm or less, or within a range of about 10 mm to about 50 mm, or about 20 mm to about 50 mm from a peripheral edge of glass ribbon 103.

Support rings 305 may be spaced along shaft 310 such that each support ring 305 does not contact an adjacent support ring 305. In some embodiments, support rings 305 are evenly spaced along shaft 310. As shown in FIG. 3 and as discussed above, support rings 305 may be positioned towards outer, peripheral ends of shaft 310 in order to contact outer, peripheral ends of glass ribbon 103. Support rings 305 may extend around an entire outer circumference of shaft 310. In some embodiments, support rings 305 have a width (along a lengthwise direction of shaft 310) of about 1 mm or greater, or about 5 mm or greater, or about 10 mm or greater, or about 15 mm or greater, or about 20 mm or greater. Additionally or alternatively, the width of support rings 305 is about 50 mm or less, or about 45 mm or less, or about 40 mm or less, or about 35 mm or less, or about 30 mm or less, or about 25 mm or less. In some embodiments, the width is about 1 mm to about 50 mm, or about 5 mm to about 45 mm, or about 10 mm to about 40 mm, or about 15 mm to about 35 mm, or about 20 mm to about 25 mm. Furthermore, support ring 205 has an outer diameter of about 5 mm or greater, or about 10 mm or greater, or about 15 mm or greater, or about 20 mm or greater, or about 25 mm or greater, or about 30 mm or greater, or about 35 mm or greater, or about 40 mm or greater, or about 45 mm or greater, or about 50 mm or greater. Additionally or alternatively, the outer diameter is about 500 mm or less, or about 400 mm or less, or about 300 mm or less, or about 200 mm or less, or about 100 mm or less, or about 75 mm or less, or about 50 mm or less. In some embodiments, the outer diameter is in a range from about 5 mm to about 500 mm, or about 10 mm to about 450 mm, or about 15 mm to about 400 mm, or about 20 mm to about 350 mm, or about 25 mm to about 300 mm.

Because support rings 305 extend radially outward from shaft 310, glass ribbon 103 (when supported by conveying apparatus 110) may engage and contact support rings 305 but not shaft 310. Thus, support rings 305 may contact glass ribbon 103 to convey glass ribbon along travel path 134. Furthermore, glass ribbon 103 may only contact support rings 305 on each roller (and not the remaining components of the rollers). Because glass ribbon 103 only contacts support rings 305, such reduces/prevents any damage to glass ribbon 103, such as scratching or denting of glass ribbon 103.

Support rings 305 may be comprised of an elastomeric material such as, for example, silicone, nitrile, Viton™, or other organic materials. In some embodiments, the material of support rings 305 is heat resistant up to, for example, about 300° C. As such, support rings 305 can contact glass ribbon 103 while avoiding negative effects (e.g., degradation, wear, etc.) due to the heat of glass ribbon 103. As discussed above, support rings 305 may be circumferential members that extend around the entire circumference of shaft 310. In some embodiments, support rings 305 are elastomeric O-rings. In other embodiments, one or more support rings 305 comprise a contactless support apparatus such as, for example, an air bearing that emits air towards glass ribbon 103. Due to the impingement of the air upon glass ribbon 103, the air bearing can support glass ribbon 103 while not contacting glass ribbon 103 (e.g., with glass ribbon 103 spaced a distance apart from the air bearing). The air bearing can comprise a hollow interior that receives air (e.g., pressurized air) from a source.

As discussed above, support rings 305 contact outer, peripheral portions of glass ribbon 103. Thus, the plurality of rollers 103, including support rings 305, do not contact a center portion of glass ribbon 103. Such may reduce or prevent any negative effects to a center portion of glass ribbon 103, such as any degradation or wear of glass ribbon 103.

Shaft 310 may have a circular cross-sectional shape with a diameter of about 40 mm or greater, or about 50 mm or greater, or about 60 mm or greater, or about 70 mm or greater, or in a range of about 40 mm to about 80 mm, or about 50 mm to about 70 mm, or about 40 mm to about 50 mm. However, it is also contemplated that shaft 310 may have other cross-sectional shapes. Furthermore, it is also contemplated that one or more shafts 310 may have a different diameter and/or cross-sectional shape from one or more other shafts 310 on different rollers on conveying apparatus 110. As discussed above, shaft 310 does not contact glass ribbon 103. Each shaft 310 may further comprise a gear 320 connected to support arms 205, 215. As shown in FIG. 3, first roller 301 comprises two gears 320. Rotation of gears 320 causes rotation of shaft 310, which further causes rotation of support rings 305. As discussed above, rotation of support rings 305 causes glass ribbon 103 to be conveyed along conveying apparatus 110.

It is also noted that in some embodiments, one or more shafts 310 of the plurality of rollers 203 may not rotate. Instead, one or more shafts 310 may be stationary members that help to reduce any sag of glass ribbon 103 while not any imparting any conveyance to glass ribbon 103.

Glass ribbon 103 may be formed of coated or uncoated glass, glass-ceramic, and/or ceramic material. Exemplary glass compositions include, for example, borosilicate glass, soda-lime glass, aluminosilicate glass, alkali aluminosilicate, alkaline earth aluminosilicate glass, alkaline earth boro-aluminosilicate glass, fused silica, or crystalline materials such as sapphire, silicon, gallium arsenide, or combinations thereof. In some embodiments, the glass may be ion-exchangeable, such that the glass composition can undergo ion-exchange for glass strengthening before or after processing the substrate. For example, the glass may comprise ion exchanged and ion exchangeable glass, such as Corning® Gorilla® Glass available from Corning Incorporated of Corning, NY. Further, the glass may have coefficients of thermal expansion (CTE) of from about 6 ppm/° C. to about 10 ppm/° C. Other exemplary glasses include EAGLE XG® and CORNING LOTUS™ Glass available from Corning Incorporated of Corning, NY.

In other embodiments, ribbon 103 comprises glass ceramics or crystals such as alumina, zirconia, sapphire, or zinc selenide. It is also contemplated in other embodiment that ribbon 103 comprises a polymeric material (coated or uncoated), such as a transparent plastic material. Furthermore, in some embodiments, ribbon 103 may comprise a metal or metal alloy (coated or uncoated). Thus, the embodiments of the present disclosure are not limited to ribbon 103 being formed of glass.

In some embodiments, glass ribbon 103 is a thin member with a thickness of about 100 microns or less, or about 90 microns or less, or about 80 microns or less, or about 70 microns or less, or about 60 microns or less. Additionally or alternatively, glass ribbon 103 has a thickness of about 20 microns or greater, or about 30 microns or greater, or about 40 microns or greater, or about 50 microns or greater, or about 60 microns or greater. In some embodiments, the thickness of glass ribbon 103 in a range from about 20 microns to about 100 microns, or about 40 microns to about 70 microns.

Due at least in part to the small thickness of glass ribbon 103, in traditional conveying apparatuses, such thin glass ribbon may sag in between rollers. Thus, the glass ribbon may bulge or sink downward in between adjacent rollers under the influence of gravity. However, embodiments of the present disclosure include a tensioning roller that reduces/prevents such sagging between adjacent rollers. As discussed further below, the tensioning roller advantageously reduces/prevents such sagging of glass ribbon 103 while limiting the contact of the rollers with glass ribbon 103.

It is also noted that conveying apparatus 110 may be used with thicker glass ribbon than disclosed above and is not limited to the glass ribbon dimensions disclosed above.

FIG. 3 shows an embodiment in which fifth roller 303 is a tensioning roller 400. It is further noted that one or more other rollers of the plurality of rollers 203 (such as, for example, third roller 301 and/or fourth roller 302) may also be a tensioning roller. For example, each of the rollers of the plurality of rollers 203 may be a tensioning roller 400. In other embodiments, one or more, or two or more, or three or more, or four or more, or five or more, or six or more, or seven or more, or eight or more, or nine or more, or ten or more of the rollers may be tensioning rollers 400. For example, about half of the rollers of the plurality of rollers 203 may be tensioning rollers 400. Additionally, tensioning rollers 400 may be spaced apart along the length of conveying apparatus 110 in various configurations. In one particular embodiment, every other roller of the plurality of rollers 203 is a tensioning roller 400.

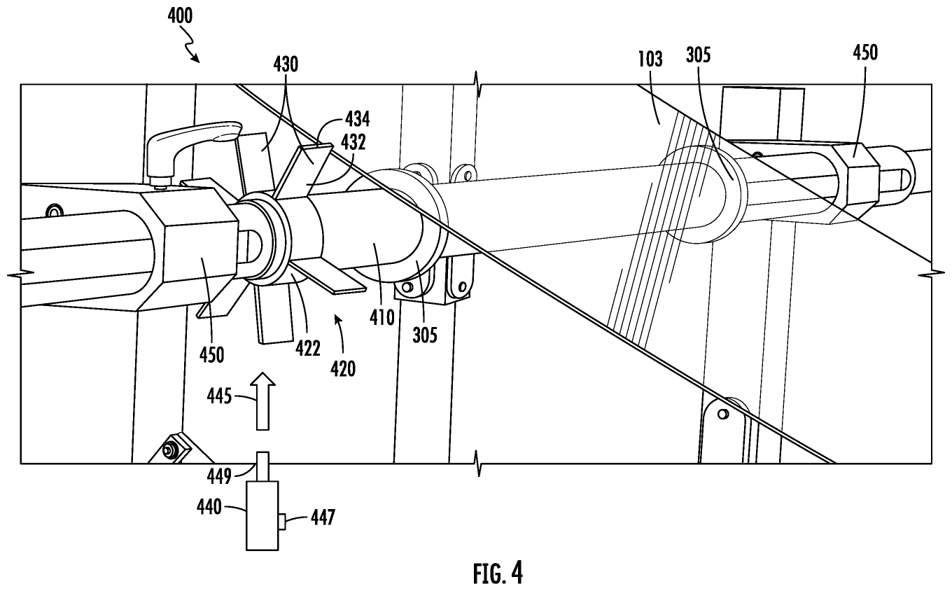

Tensioning roller 400 comprises a shaft 410 (similar to shaft 310 discussed above) and a rotation wheel 420 disposed on shaft 410. As also shown in FIG. 4, rotation wheel 420 comprises a plurality of spokes 430 that extend radially outward from shaft 410. Spokes 430 are each a projecting member such as a paddle, blade, extension, or protrusion. Furthermore, spokes 430 are configured to rotate about a longitudinal axis of shaft 410 to cause glass ribbon 103 to be conveyed along travel path 134 and in the travel direction 150. More specifically, a flow generator 440 (FIG. 4) directs a flow of fluid 445 to the plurality of spokes 430 to cause their rotation. Rotation of spokes 430 causes rotation of shaft 410, which in turn causes the conveyance of glass ribbon 103. In some embodiments, shaft 410 comprises support rings 305, as discussed above. Thus, in these embodiments, rotation of spokes 430 causes rotation of shaft 410, which in turn causes rotation of support rings 305 and, thus, conveyance of glass ribbon 103.

Rotation wheel 420 may have an outer diameter of about 30 mm or greater, or about 40 mm or greater, or about 50 mm or greater, or about 60 mm or greater, or about 70 mm or greater, or about 80 mm or greater, or about 90 mm or greater, or about 100 mm or greater, or in a range from about 50 mm to about 100 mm, or about 60 mm to about 90 mm. The outer diameter of rotation wheel 420 may be the outer periphery of spokes 430. Therefore, spokes 430 may each have a length from a first end 432 to a second end 434 of about 1 mm or greater, or about 5 mm or greater, or about 8 mm or greater, or about 10 mm or greater, or about 12 mm or greater, or about 15 mm or greater, or about 18 mm or greater, or about 20 mm or greater, or in a range from about 1 mm to about 50 mm, or about 5 mm to about 20 mm, or about 10 mm to about 15 mm, or about 12 mm to about 14 mm, or about 5 mm to about 40 mm, or about 10 mm to about 35 mm, or about 15 mm to about 30 mm. As shown in FIG. 4, a first end 432 of spokes 430 may extend from a base of 422 of rotation wheel 420 and a second end 434 of spokes 430 may be a free end. Thus, second end 434 is radially outward of first end 432.

Spokes 430 may project radially outward from base 422 of rotation wheel 420 such that each spoke 430 is separated from an adjacent spoke 430. Thus, a gap exists between adjacent spokes 430. In some embodiments, the minimum gap between adjacent spokes (i.e., a straight line between the adjacent spokes 430) is about 2 mm or greater, or about 5 mm or greater or about 8 mm or greater, or about 10 mm or greater, or about 15 mm or greater, or about 20 mm or greater, or about 25 mm or greater, or about 30 mm or greater. Additionally or alternatively, the minimum gap between adjacent spokes 430 is about 80 mm or less, or about 75 mm or less, or about 70 mm or less, or about 65 mm or less, or about 60 mm or less, or about 55 mm or less, or about 50 mm or less, or about 45 mm or less, or about 40 mm or less. In some embodiments, the minimum gap is in a range between about 5 mm and about 80 mm, or about 10 mm to about 70 mm, or about 20 mm to about 60 mm. Rotation wheel 420 may comprise about eight or more spokes, or about nine or more spokes, or about ten or more spokes, or about 20 or more spokes, or about 40 or more spokes, or about 80 or more spokes, or about 100 or more spokes. Additionally or alternatively, rotation wheel 420 may comprise about 500 or less spokes, or about 250 or less spokes, or about 200 or less spokes, or about 100 or less spokes, or about 80 or less spokes, or about 40 or less spokes, or about 20 or less spokes, or about 18 or less spokes, or about 16 or less spokes, or about 14 or less spokes, or about 12 or less spokes, or about 10 or less spokes, or about 8 or less spokes. In some embodiments, rotation wheel 420 comprises about 8 to about 20 spokes or about 12 to about 40 spokes.

Furthermore, spokes 430 may each have a width of about 1 mm to about 50 mm, or about 5 mm to about 40 mm, or about 10 mm to about 35 mm, or about 15 mm to about 30 mm. As discussed above, a length of each spoke 430 may be about 1 mm to about 50 mm, or about 5 mm to about 40 mm, or about 10 mm to about 35 mm, or about 15 mm to about 30 mm. In some embodiments, spokes 430 are square components with length and width dimensions in a range of about 2×2 mm to about 50×50 mm, or about 5×5 mm to about 40×40 mm, or about 10×10 mm to about 35×35 mm, or about 15×15 mm to about 30×30 mm. Thus, spokes 430 may have a surface area of about 1 mm² to about 2,500 mm², or about 25 mm² to about 1,600 mm², or about 100 mm² to about 1,225 mm², or about 225 mm² to about 900 mm². Spokes 430 should be of sufficient size so that flow generator 440 is able to direct the flow of fluid 445 to spokes 430 so that the flow of fluid 445 loads spokes 430 and spokes 430 apply a torque to rotation wheel 420, which in turn applies a torque to shaft 410. It is also noted that one or more spokes 430 may have a different size (e.g., length, width, surface area) from one or more other spokes 430 on conveying apparatus 110.

In the embodiment of FIGS. 3 and 4, tensioning roller 400 comprises one rotation wheel 420. However, it is also contemplated that tensioning roller 400 may comprise two or more, or three or more, or four or more tensioning rollers 400. For example, in some embodiments, tensioning roller 400 may comprise two rotation wheels 420, such that each rotation wheel is disposed at an outer, peripheral end of shaft 410. As also shown in FIGS. 3 and 4, tensioning roller 400 may be disposed peripherally outward of glass ribbon 103. Thus, the outer peripheral ends of glass ribbon 103 are disposed radially inward (i.e., toward a center of glass ribbon 103) of tensioning roller 400.

In some embodiments flow generator 440 is a device or apparatus that drives and directs the flow of fluid 445, such as air or water, so that a velocity vector of the fluid is changed. Thus, flow generator 440 directs the velocity vector of the fluid towards spokes 430 to influence or drive spokes 430 (which causes rotation of spokes 430). In some embodiments, the flow of fluid 445 is a narrow, directable stream of fluid. Flow generator 440 may be, for example, a fan, a compressed nozzle, or a fluid jet. In some particular embodiments, flow generator 440 is a compressed air nozzle or a compressed water nozzle. Air jets may be particularly useful flow generators 440 to control or direct a narrow stream of fluid (e.g., air). Other embodiments of flow generator 440 include a device that heats a fluid, such as water, to produce a directed flow of steam. Flow generator 440 may include a motor that drives impellers, rotors, compressors, and/or blowers. Still other flow generators 440 may include bellows, turbines, etc. In the embodiment of FIG. 4, flow generator 440 is an air jet that comprises a nozzle 449 through which the flow of fluid 445 is ejected and directed towards rotation wheel 420. In other embodiments, flow generator 440 comprises a water jet or a vacuum hose such that the flow of fluid of fluid is water. Flow generator 440 may be pivotable with regard to rotation wheel 420 in order to accurately direct the flow of air 445 at rotation wheel 420.

Although not shown, flow generator 440 may comprise a reservoir for holding the fluid and a conduit that connects the reservoir with nozzle 449. The reservoir may be pressurized so that the fluid flows from nozzle 449 and into contact with spokes 430. Flow generator 440 is configured to not move particulates in the surrounding air onto the equipment or onto glass ribbon 103, which could cause defects in glass ribbon 103. In some embodiments, the flow of fluid 445 is filtered so not to generate any pollution.

Flow generator 440 provides a directable and easily controlled, with great specificity, flow of fluid 445 to rotation wheel 420. Such allows spokes 430 of rotation wheel 420 to be driven with a higher degree of specificity than when using conventional rollers driven by a gear or belt. More specifically, rotation wheel 420, when driven by flow generator 440, provides a conveying force on glass ribbon 103 to convey the glass ribbon along conveying apparatus 110 while limiting torque of tensioning roller 400. By limiting the torque of tensioning roller 400 and, therefore, by limiting the rotational velocity of tensioning roller 400, the roller does not rotate at a rotational rate greater than a conveyance rate of glass ribbon 103. Therefore, tensioning roller 400 is able to convey glass ribbon 103 while not imposing a downward speed on glass ribbon 103. In conventional conveyance apparatuses that use a gear or belt to drive rotation rollers, the rollers are not driven with the same delicate and precise nature as in the embodiments disclosed herein. Therefore, the conventional rotation rollers may be rotated with a greater rotational rate than a conveyance rate of the glass ribbon. Due to the increased rotational rate of the conventional rotation rollers, the rollers impart a downward force on the glass ribbon. This causes the glass ribbon to move downward at a rate faster than its conveyance rate, which can cause slippage between the rollers and the glass ribbon. Any slippage between the rollers and the glass ribbon can cause support ring 305 and/or shaft 310 to rub on the glass ribbon, which can cause particle breakage and pollution, resulting in imperfections in the glass ribbon. In contrast to such conventional rotation rollers, tensioning rollers 400 advantageously do not impose any downward force on glass ribbon 103 that would cause slippage between the rollers and glass ribbon 103.

Although tensioning rollers 400 do not impose such a downward force on glass ribbon 103 to cause slippage between these components, tensioning rollers 400 do impart a conveying force on glass ribbon 103 to cause glass ribbon to be conveyed along third travel path 134. The conveying force imparts a tension on glass ribbon 103 so that it is constantly pulled downward, towards second end 116 of conveying apparatus 110. In particular, tensioning rollers 400 impart a conveying force on glass ribbon 103 that enables even thin glass ribbon 103 (such as with a thickness of about 100 microns or less) to be conveyed. In conventional conveyance apparatuses, the friction from the rotation rollers imposes an upward force on the glass ribbon, which can prohibit thin glass ribbon from being conveyed downward along the apparatus. This is not as much of a problem with thicker glass ribbon, where the force of gravity helps to counteract such friction and move the thicker glass ribbon downward along the conveyance apparatus. However, due to the smaller size of the thinner glass ribbon, its force of gravity does not counteract the friction of the rollers. Therefore, a higher conveyance force is required to convey such thinner glass ribbon. Thus, tensioning rollers 400, of the embodiments disclosed herein, not only provide a higher conveyance force but also a smaller rotational rate compared to conventional conveyance apparatuses. Such advantageously allows conveying apparatus 110 to convey thin glass ribbons while not causing any slippage between conveyance apparatus 110 and the glass ribbon.

Tensioning rollers 400 may exert a conveying force on glass ribbon of about 15 g or more, or about 20 g or more, or about 25 g or more, or about 30 g or more. Additionally or alternatively, the conveying force is about 60 g or less, or about 55 g or less, or about 50 g or less, or about 45 g or less, or about 40 g or less in order to prevent and/or reduce any breakage of glass ribbon 103. It is noted that too much conveying force on glass ribbon 103 may exert too much tension on the glass, which can cause the glass to break. In some embodiments, the conveying force of tensioning rollers 400 on glass ribbon 103 is in a range from about 15 g to about 60 g, or about 20 g to about 50 g, or about 25 g to about 45 g, or about 30 g to about 40 g. In some embodiments, the conveying forces disclosed herein are for a glass ribbon 103 with a width of about 10 mm or greater, or about 25 mm or greater, or about 50 mm or greater, or about 75 mm or greater, or about 100 mm or greater, or about 200 mm or greater, or about 300 mm or greater, or about 400 mm or greater, or about 500 mm or greater, or about 2 m or smaller, or about 1 m or smaller, or in a range from about 10 mm to about 2 m. Other conveying forces may be used than disclosed herein, such as, for example, for use with wider glass ribbons.

As discussed above, flow of fluid 445 from flow generator 440 is easily controlled with great specificity. Therefore, flow generator 440 is configured to precisely control the torque of tensioning roller 400 and, thus, the conveying force of tensioning roller 400. More specifically, flow generator 440 is configured to change the conveying force of tensioning rollers 400 on the order of a microgram. Such allows the speed of glass ribbon 103, along third travel path 134, to also be precisely controlled.

The conveying force on glass ribbon 103 may cause glass ribbon 103 to be conveyed along conveying apparatus 110 with a speed of about 3 m/min or greater, or about 5 m/min or greater, or about 10 m/min or greater, or about 13 m/min or greater, or about 15 m/min or greater, or about 20 m/min or greater, or about 23 m/min or greater, or about 25 m/min or greater, or about 50 m/min or greater, or about 75 m/min or greater, or about 100 m/min or greater, or about 125 m/min or greater, or about 150 m/min or greater. Additionally or alternatively, glass ribbon 103 may be conveyed along conveying apparatus 110 with a speed of about 200 m/min or less, or about 150 m/min or less, or about 100 m/min or less, or about 80 m/min or less, or about 60 m/min or less, or about 40 m/min or less, or about 35 m/min or less, or about 30 m/min or less, or about 25 m/min or less, or about 20 m/min or less, or about 15 m/min or less. In some embodiments, the speed of glass ribbon 103 is in a range from about 5 m/min to about 20 m/min along third travel path 134, or about 6 m/min to about 18 m/min, or about 8 m/min to about 15 m/min, or about 10 m/min to about 12 m/min. Flow generator 440 directs the flow of fluid 445 to spokes 430 to produce a precise speed of glass ribbon 103. In some embodiments, flow generator 440 directs the flow of fluid 445 to spokes 430 with a flow rate of about 0.5 L/second or greater, or about 0.75 L/second or greater, or about 1.0 L/second or greater, or about 1.25 L/second or greater, or about 1.5 L/second or greater, or about 1.75 L/second or greater, or about 2.0 L/second or greater, or about 2.25 L/second or greater, or about 2.5 L/second or greater, or about 2.75 L/second or greater, or in a range from about 1.0 L/second to about 2.5 L/second, or about 1.25 L/second to about 2.0 L/second, or about 1.5 L/second to about 1.75 L/second, or about 1.0 L/second to about 1.5 L/second. The flow rate can be adjusted based upon, for example, the size of spokes 430 and/or the thickness of glass ribbon 103. Air flow valve 447 on flow generator 440 adjusts the flow rate.

In some embodiments, glass ribbon 103 that is conveyed along third travel path 134 of conveying apparatus 110 comprises a portion of a larger glass ribbon that has broken off from the larger glass ribbon. In conventional conveyance apparatuses, when a portion of a glass ribbon breaks off, the conventional apparatus may not have enough conveyance force to pull that broken portion downward. Instead, the broken portion may move upward due to the frictional force of the rollers (as discussed above). Such may require the entire glass manufacturing system 100 (including forming apparatus 120) to be turned off and powered down in order to remove the broken portion, which causes time delay and added expense. However, conveying apparatus 110, of the embodiments disclosed herein, has a sufficient conveyance force to pull such broken portions of the glass ribbon downward along third travel path 134. Therefore, the broken portion of glass ribbon 103 can be conveyed downward along conveying apparatus 110 without any downtime of the system.

Conveying apparatus 110 also prevents and/or reduces any sag of glass ribbon 103 (even thin glass ribbon with a thickness of about 100 microns or less). The plurality of rollers 103 (which include tensioning rollers 400) may be spaced a sufficient distance and may exert a sufficient conveyance force on glass ribbon 103 to prevent and/or reduce any sag of glass ribbon 103.

As shown in FIG. 4, tensioning roller 400 further comprises two stabilizing members 450 that connect shaft 410 to the support arms of conveying apparatus 110 (as discussed above). Furthermore, tensioning roller 400, in the embodiment of FIG. 4, comprises support rings 305 so that tensioning roller 400 only contacts outer, peripheral portions of glass ribbon 103 and does not contact a center portion of glass ribbon 103. More specifically, only support rings 305 of tensioning roller 400 contact glass ribbon 103. The other components of tensioning roller 400 (including shaft 410 and rotation wheel 420) do not contact glass ribbon 103.

It is also contemplated in other embodiments that flow generator 440 and rotation wheel 420 are replaced with, for example, a torque motor or a motor with a torque limiter, such as a clutch, to drive tensioning roller 400 (and, thus, to drive shaft 410 and support rings 305). For example, the torque motor may have a very low torque in order to precisely control the rotation and torque of tensioning roller 400. In yet other embodiments, flow generator 440 and rotation wheel 420 may be replaced with an electric motor to drive tensioning roller 400.

As discussed above, embodiments of the present disclosure comprise methods of manufacturing glass ribbon 103 by directing the flow of fluid 445 to the plurality of spokes 430 to rotate the plurality of spokes 430 and convey glass ribbon 103 along travel path 134 of conveying apparatus 110 in travel direction 150 such that the plurality of spokes 430 do not contact glass ribbon 103 or shaft 410.

It should be understood that while various embodiments have been described in detail relative to certain illustrative and specific examples thereof, the present disclosure should not be considered limited to such, as numerous modifications and combinations of the disclosed features are possible without departing from the scope of the following claims.

1. A manufacturing system comprising:
a conveying apparatus comprising a plurality of rollers that form a travel path along which a ribbon is configured to be conveyed in a travel direction, the plurality of rollers comprising at least a tensioning roller,
the tensioning roller comprising a shaft and a rotation wheel with a plurality of spokes that extend radially outward from the shaft, the plurality of spokes being configured to rotate about a longitudinal axis of the shaft to cause the ribbon to be conveyed in the travel direction, and
a flow generator configured to cause rotation of the plurality of spokes.

2. The manufacturing system of claim 1, wherein the flow generator is configured to direct a flow of fluid to the spokes such that the flow of fluid loads the spokes and the spokes apply a torque to the rotation wheel.

3. The manufacturing system of claim 1, wherein the travel path is a curved path.

4. The manufacturing system of claim 1, wherein the travel direction comprises a first travel direction and a second travel direction, the first travel direction having a different slope from the second travel direction.

5. The manufacturing system of claim 1, wherein the spokes each have a surface area of about 1 mm² to about 2,500 mm². Page 4

6. The manufacturing system of claim 1, further comprising one or more support rings that extend radially outward from the shaft, the support rings being configured to contact outer, peripheral portions of the ribbon.

7. The manufacturing system of claim 1, wherein the shaft has an outer diameter in a range from about 40 mm to about 80 mm.

8. The manufacturing system of claim 1, wherein the rotation wheel has an outer diameter in a range from about 50 mm to about 100 mm.

9. The manufacturing system of claim 1, wherein the flow generator is an air jet.

10. The manufacturing system of claim 1, wherein the flow generator is a compressed nozzle.

11. The manufacturing system of claim 1, wherein a length of the shaft is perpendicular to the travel direction of the ribbon.

12. The manufacturing system of claim 1, further comprising a forming apparatus configured to form the ribbon.

13. The manufacturing system of claim 1, further comprising the ribbon coupled to the plurality of rollers such that the ribbon does not contact the shaft or the rotation wheel.

14. The manufacturing system of claim 1, wherein the ribbon is comprised of glass, glass ceramic, or ceramic.

15. A method of manufacturing a ribbon, the method comprising:
rotating a plurality of spokes and conveying a ribbon along a travel path of a conveying apparatus in a travel direction such that the plurality of spokes do not contact the ribbon,
the plurality of spokes being attached to a shaft such that the shaft does not contact the ribbon.

16. The method of claim 15, wherein the spokes are connected to a rotation wheel, the method further directing a flow of fluid to the spokes such that the flow of fluid loads the spokes and the spokes apply a torque to the rotation wheel.

17. The method of claim 15, wherein the travel path is a curved path.

18. The method of claim 15, further comprising conveying the ribbon in a first travel direction and in a second travel direction of the travel direction, the first travel direction having a different slope from the second travel direction.

19. The method of claim 15, further comprising directing a flow of fluid to the spokes with a flow generator to rotate the spokes.

20. The method of claim 19, wherein the flow generator is an air jet.

21. The method of claim 19, wherein the flow generator is a compressed nozzle.

22. The method of claim 15, wherein the ribbon is comprised of glass, glass ceramic, or ceramic.

23. The method of claim 15, further comprising directing the flow of fluid to the spokes with a flow rate of about 1.0 L/second to about 2.5 L/second.

24. The method of claim 23, further comprising directing the flow of fluid to the spokes with a flow rate of about 1.0 L/second to about 1.5 L/second.

25. The method of claim 15, further comprising conveying the ribbon at a speed of about 5 m/min or greater.

26. The method of claim 25, further comprising conveying the ribbon at a speed of about 15 m/min or greater.

27. The method of claim 15, wherein the ribbon has a width of about 10 mm to about 2 m and
further comprising exerting a conveying force of at least about 20 g on the ribbon to convey the ribbon along the travel path.

28. The method of claim 27, further comprising exerting a conveying force of no more than about 50 g on the ribbon to convey the ribbon along the travel path.

29. The method of claim 15, wherein the ribbon has a width of about 10 mm to about 2 m, and
further comprising exerting a conveying force of no more than about 50 g on the ribbon to convey the ribbon along the travel path.

30. The method of claim 15, wherein the conveying apparatus does not contact a center portion of the ribbon.

31. The method of claim 15, wherein the ribbon comprises a portion of a larger glass, glass ceramic, or ceramic ribbon that has broken off from the larger glass, glass ceramic, or ceramic ribbon.

32. The method of claim 15, wherein the conveying apparatus comprises a plurality of rollers that form the travel path along which the ribbon conveys, a tensioning roller of the plurality of rollers comprising the plurality of spokes.

33. The method of claim 32, wherein a length of each of the plurality of rollers is perpendicular to the travel direction of the ribbon.

34. The method of claim 15, wherein one or more support rings extend radially outward from the shaft and contact outer, peripheral portions of the ribbon to convey the ribbon along the travel path.
